(19) United States
(12) Patent Application Publication
(10) Pub. No.: US 2009/0097895 A1
(43) Pub. Date: Apr. 16, 2009

(54) THERMAL TIME STAMP PRINTER

(75) Inventors: John W. Taylor, Chapel Hill, NC (US); W. Glenn Robbins, Raleigh, NC (US)

Correspondence Address: INTELLECTUAL PROPERTY / TECHNOLOGY LAW, PO BOX 14329, RESEARCH TRIANGLE PARK, NC, 27709, US

(73) Assignee: ACROPRINT TIME RECORDER COMPANY, Raleigh, NC (US)

(21) Appl. No.: 11/871,991

(22) Filed: Oct. 13, 2007

(51) Int. Cl. B41J 2/325

(52) U.S. Cl. 400/120.01

(57) ABSTRACT

A thermal time date stamp including a printing apparatus, system and method for recording the date and time on a flat paper sheet includes a paper guide for transporting the paper beneath a thermal print head and thermal transfer ribbon, a display for confirming the time and date that is synchronized to the print, and a microprocessor for inputting a graphic image of the time and date displayed to the print head.

### BACKGROUND OF THE INVENTION

1. Field of the Invention

This invention pertains to a device and system for applying thermally-printed indicia to a sheeting in a direction normal to the direction of movement of the sheeting past a print head. The present invention relates generally to a printing device usefully employed as a time recorder, printing the time, date, location and other information onto a time card or document.

2. Description of the Prior Art

Time stamps are commonly used for printing time, date and other information on a time card or other media.

However, traditional time clocks employ dot matrix printers and have many bulky components, such as a cam, motor, drive train, printer and printer ribbon, which can obscure the view of the operator and making it difficult to line up the time card at the appropriate position. Typically, these devices employ only a small window through which the operator must view the time card from an obscure angle.

It is therefore desirable to provide a printing device in which some of the bulky components, e.g., the motor and drive train are removed from the front of the top portion of the device so that the size of the top portion can he reduced thereby improving the ability of the operator to view the alignment of the time card or other media in relation to the printer. It is also desirable to reposition or remove other elements, e.g., a cam shaft, to allow for improved viewing of the time card alignment. This invention utilizes a thermally-activated printer to achieve these objectives.

Present designs for the mechanical time and date stamps also require a manual operation to synchronize the display of the time and date to what is printed and it is desirable to have the display of the time and date be synchronized to what is being printed or stamped.

It is also desirable to maintain the time and date during the loss of power. For mechanical time and date stamps, the time and/or date need to be manually altered to reflect the current time and/or date that is to be printed or stamped.

### SUMMARY OF THE INVENTION

In order to overcome the noted problems associated with conventional time clocks, the present invention uses a thermal printing apparatus having a print head arrangement that comprises a driven roller and a thermal print head. A thermal print receptive sheeting is disposed therebetween. The thermal print head may comprise heatable resistive elements in a thermal heating system. External standard paper sheeting, time card sheeting, or envelopes are used as the printable media. The ribbon of thermally sensitive material is held upon and tensioned by a reel and is collected on a driven reel. The sheeting is transported beneath the ribbon by a sheeting transport means known in prior art, for example, a friction drive mechanism using a stepper motor. The print head remains stationary and makes contact with thermal transfer ribbon and transfers the image from the print head to the sheeting as the sheeting moves past the print head. When transfer of the image is completed, in this instance a time and date, the print head and ribbon assembly may be retractably disengaged from the document feeder.

By use of a time recording mechanism that incorporates a thermal printing device to print time and date information on a record paper to record the time and date, the record paper or document, the following objectives are achieved in a time stamp:
1. The time clock is less bulky than possible heretofore and the time and date printed on the paper record is readily viewable to the operator;
2. The time and date information can be permanently maintained within the thermal time stamp printer.
3. Time and date information for the Time Stamp, can be set via a control panel independently of an external computing device or if desired, the time and date information for the Time Stamp, can be set via an external computing device.
4. Through an external computing device, the time stamp time and date can be merged with an image that is downloaded to the thermal time stamp printer that can be transferred to a record paper or document.
5. The thermal time stamp device does not have to be connected to an external computing device to operate.
6. The thermal time stamp device stated is capable of transferring a graphic image or insignia to simulate an official seal.
7. The thermal time stamp device is capable of transferring a graphic image to simulate a written signature.
8. Via a computing device, the time and date stamped on said record can be recorded; and
9. A graphic image that is to be transferred to a paper record or document can be permanently set in a secure memory.

### BRIEF DESCRIPTION OF THE DRAWINGS

Further objects and advantages of the invention will become more apparent from the following description and claims, and from the accompanying drawings, wherein:

FIG. 1 is a perspective view of the thermal printing device of the present invention; and

FIG. 2 is a schematic block diagram illustrating the controls for the printer device of FIG. 1.

### DETAILED DESCRIPTION OF THE PREFERRED EMBODIMENT

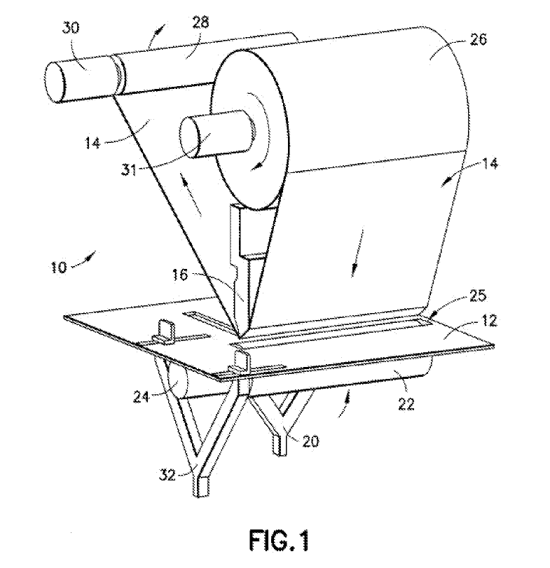

Referring now to the drawings in detail, wherein like numerals indicate like elements throughout the several views, the thermal printer 10 of the present invention includes a paper guide 12 for presenting a printable area of paper sheeting or other recordable media (not shown) insertable by the operator-user beneath a thermal transfer ribbon 14 and thermal print head 16. The print head 16 will transfer a graphic from the ribbon 14 to the paper and in the embodiment of the invention illustrated in FIG. 1 a time and date illustrated on a suitable LCD digital display 18. The paper or printable area is limited in movement by an adjustable stop 20 disposed in the path of movement of the paper. A platen roller 22 driven by a stepping motor or the like 24 advances the paper until it is positioned beneath the ribbon 14 and thermal print head 16 and is in contact with the paper through a slot 25 in paper guide 12. The ribbon 14 is positioned beneath the print head 16 above the paper guide 12 between a ribbon feed roll 26 controlled by the ribbon feed roll motor 31 and a ribbon take-up roll 28 rotated by a take-up motor 30. The moveable paper guide stop 32 determines the position from the side edge of the paper that the time and date stamp or print will be located. The printed material is sensed by the document sensor or stop 20 upon which the printing process will begin. The document sensor or stop 20 is also positioned so that at a predetermined distance from the leading edge of the document, the printing will begin. Upon activation of the thermal print head 16 after location of the paper beneath the ribbon and print head, the time and date on display 18 is recorded and stamped on the paper.

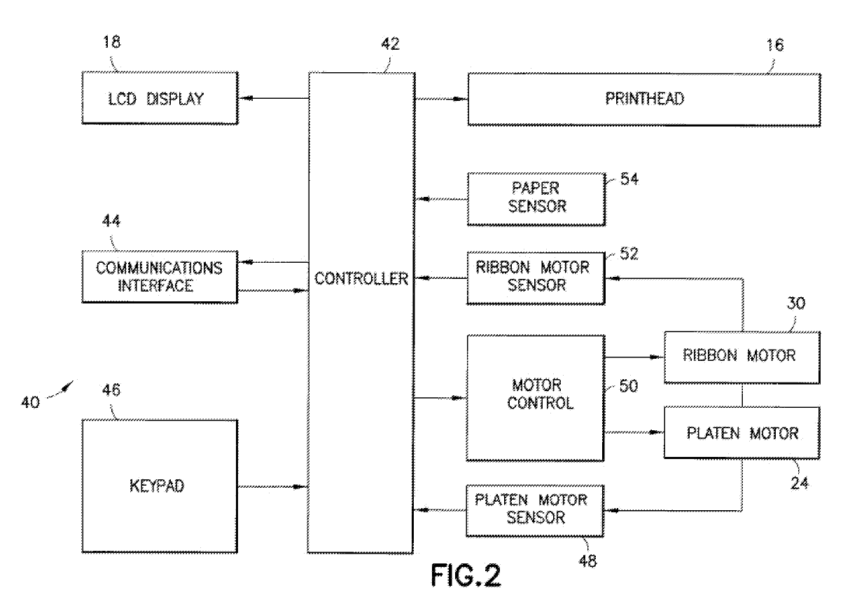

The operation of the thermal time stamp device 10 is synchronized and controlled as illustrated in FIG. 2.

With reference to FIG. 2, there is shown the control electronics 40 necessary to operate the Thermal Time Stamp Printer 10. The controller 42 is the central processing unit that controls the operation of the Thermal Transfer Time Stamp. The controller 42 is preferably a microprocessor with sufficient computing capacity to perform all operations of the Thermal Transfer Time Stamp.

Connected to the controller 42 is the LCD display 18, a communications interface 44, keypad 46, platen sensor 48, motor control electronics 50, ribbon motor sensor 52, paper sensor 54, and the thermal print head 16.

In operation, the controller 42 receives data through the communications interface 44 which can be Ethernet, USB, Serial, or other means necessary to transfer data to the memory contained within the controller 42 to cause the thermal printing process to occur. Once the data has been transferred, the thermal time stamp can be removed from the external communications device or computing device to operate independently. The keypad 46 connected to the controller 42 allows the user to enter information as to the quantity, initial printer setup, or other input required by the operator to facilitate printing. The LCD display 18 is to display the current status, e.g., time and date, of the thermal time stamp printer 10 or may be used to display requests of the user-operator for further information regarding the operation.

The paper sensor 54 detects the presence of the material to which a time stamp date, time or other graphic material is to be printed on. This sensor can be an optical sensor which operates by interrupting an infrared light beam or this sensor can be a mechanical switch or stop 20 which will detect the material in the printing path to be printed upon.

The motor control electronics 50 controls the platen motor 24 and ribbon motor 30 to cause the thermal ribbon material and paper sheeting to be printed upon to move thru the printer feed path. The ribbon motor 30 has a sensor 52 to control the operation of the ribbon motor 30. The platen motor 24 has a sensor 54 to control the operation of the platen motor. These sensors 52 and 54 sense the current drawn by their respective motor to ensure that proper tension is applied to the ribbon and to cause the material to be printed upon to be advanced in synchronization with the ribbon through the printing path.

The primary function of the controller 42 is to receive data from an external source, such as a personal computer, and to operate upon this data to form an image that is to be applied to the print material. This data that is operated upon is then digitized and serialized and sent to the thermal print head 16, which has a series of heat sensitive resistor elements to form and transfer the image through the ribbon 14 to the material being printed upon, as is well known in the art.

Using a personal computer, graphics-based indicia may be printed, as opposed to the less versatile single-character-based indicia. In reference to the present invention, graphics-based indicia are images that are produced by electronically formatting the image so that more than one character can he produced per electronic transmission.

With print head data processing mechanisms within thermal print head 16, the operator input is assembled by software into code suitable for controlling actuation, disengagement and transfer by the print head.

What is claimed is:

1. A time stamp printing apparatus that utilizes a thermal transfer process that can transfer a graphic image or text from a moving thermal transfer ribbon onto printable areas of a print receptive sheeting, the apparatus comprising:
(a) a thermal print head;
(b) a transport that can move the thermal print receptive sheeting past the thermal print head; said transport including a flat transport surface for recording a time and date stamp on a flat sheet of print receptive sheeting in synchronization with actuation of said print head;
(c) a thermal transfer ribbon for transfer of said time and date to the thermal print receptive sheeting; and
(d) means for moving said thermal transfer ribbon past said thermal print head.

2. The apparatus of claim 1 wherein the transport that moves the thermal print receptive sheeting past the thermal print head includes a flat transport surface for recording a count of the flat sheet of print receptive sheeting in synchronization with actuation of said print head.

3. The apparatus of claim 1 wherein said transport a can accommodate varying thickness of flat sheet print receptive sheeting that will receive the time and date stamp.

4. The apparatus of claim 1 wherein said transport can accommodate multiple flat sheets of print receptive sheeting that will receive the time and date stamp.

5. The apparatus of claim 1 wherein said flat sheeting supply is not contained within the thermal time and date stamp apparatus.

6. The apparatus of claim 1, wherein said flat transport surface comprises a platen in the form of a flat paper guide against which the thermal print head can maintain contact pressure during the transfer of said image from the ribbon to the thermal print receptive sheeting.

7. The apparatus of claim 6, wherein said sheeting is moved by a platen roller having a sheet contact surface extending through a slot in said paper guide.

8. The apparatus of claim 2, wherein the operation of said platen roller is synchronized with the operation of said ribbon moving means.

9. The apparatus of claim 1, wherein a time, date and text display forms the basis of said transfer image.

10. The apparatus of claim 8 including computer means for controlling the synchronization of said platen roller and ribbon moving means.

11. The apparatus of claim 1, including a computer operated microprocessor for inputting said transfer image to said print head.

12. A system for recording a time stamp on a sheet comprising:
(a) thermal means for forming a transferable image;
(b) thermal transfer means for receiving said transferable image; and
(c) sheet transport means for transporting a flat sheet to a position beneath said thermal means and thermal transfer means for thermally receiving said transferable image; and
(1) said transferred image including indicia indicating the time and date of said transfer.

13. The system of claim 12 including means for synchronizing the movement of said thermal transfer means and sheet transport means beneath said thermal means at the time of said image transfer.

14. The system of claim 12 including a computer operated microcontroller for inputting data to said thermal means to determine the form of said transferable image.

15. A method for recording indicia indicative of the time and date of said recording comprising the steps of:
(a) displaying said time and date for viewing;
(b) transporting a sheet of paper or other recordable media beneath a thermal print head and thermal transfer ribbon;
(c) inputting said displayed time and date to a computer operated microprocessor; and
(d) thermally printing indicia corresponding to said time and date inputted to said microprocessor onto the sheet of paper or other recordable media.

16. The method of claim 15 wherein the transporting of said sheet of paper or the like beneath the thermal print head and thermal transfer ribbon and the actuation of said thermal printing step are synchronized so as to occur substantially simultaneously.
